(19) United States
(12) Patent Application Publication
(10) Pub. No.: US 2026/0201835 A1
(43) Pub. Date: Jul. 16, 2026

(54) Heat exchanger device for an aircraft engine comprising a fuel-oil heat exchanger

(71) Applicant: Rolls-Royce Deutschland Ltd & Co KG, Blankenfelde-Mahlow (DE)

(72) Inventor: Markus BLUMRICH, Berlin (DE)

(21) Appl. No.: 19/448,539

(22) Filed: Jan. 14, 2026

(30) Foreign Application Priority Data
Jan. 14, 2025 (DE) 102025000113.4

(51) Int. Cl. F02C 7/14; F28D 7/16; F28D 21/00; F28F 27/02

(52) U.S. Cl. CPC F02C 7/14; F28D 7/16; F28F 27/02; F05D 2260/213; F28D 2021/004

(57) ABSTRACT

A heat exchanger for a gas turbine engine includes a fuel-oil heat exchanger for indirect transfer of thermal energy between fuel and oil. A feed area of the fuel-oil heat exchanger for the fuel, is delimited by a front plate through which fuel can flow and an opposite casing area. A discharge area of the fuel-oil heat exchanger is arranged on a side facing away from the feed area. Fuel is led through a bypass line extending parallel to the fuel-oil heat exchanger and having a bypass valve for controlling fuel volume flow. A part of the oil flow led through the fuel-oil heat exchanger is conducted through the casing area upstream of the fuel-oil heat exchanger, to be able to transfer thermal energy indirectly between the oil volume which flows through the casing area and the fuel in the feed area.

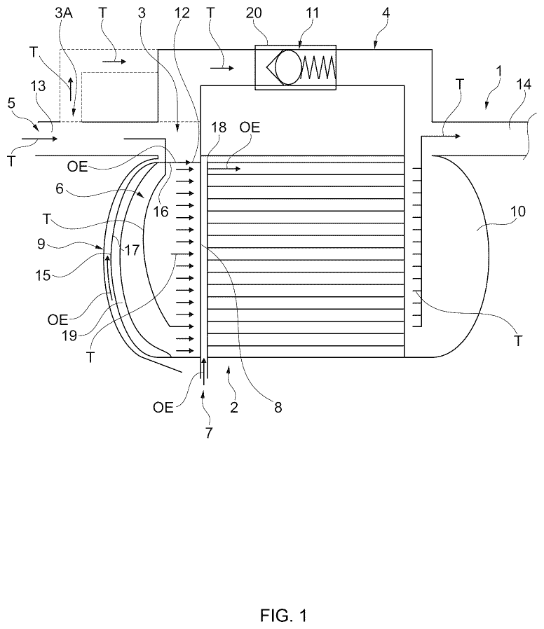

This application claims priority to German Patent Application 102025000113.4 filed Jan. 14, 2025. The entirety of this application is incorporated by reference herein.

The present disclosure relates to a heat exchanger device for an aircraft engine comprising a fuel-oil heat exchanger according to the type defined in more detail in the pre-characterizing clause of patent claim 1.

As is known, aircraft engines are also operated at ambient temperatures below the freezing point of water. During unfavourable operating states of aircraft engines, this leads to water entrained by the fuel changing from the liquid state to the solid state and being deposited in the form of ice in the fuel system. If too much ice forms during operation and blocks the flow path of the fuel, an aircraft engine can no longer be supplied with the currently required quantity of fuel which, under certain circumstances, results in a stoppage of the aircraft engine.

In order to meet the requirements on the non-steady-state icing, which forms part of the approval regulations for engines and aircraft, modern aircraft engines or gas turbine engines have what are known as fuel-oil heat exchangers, in the area of which attempts are made to set the operating temperature of the fuel to values above the freezing point of the water entrained by the fuel, by means of thermal energy which is provided from an oil circuit of the aircraft engine.

If the icing in the fuel system hampers the flow through such a fuel-oil heat exchanger, a bypass valve opens a bypass line that bypasses the fuel-oil heat exchanger. In order to maintain this additional flow path for the fuel, U.S. Pat. No. 9,823,030 B1 proposes to design such a bypass valve to be heatable.

However, the problem here is that during operation over relatively long time periods, despite the heatable bypass valve, deposited ice also blocks the flow path through the bypass line.

In order to avoid ice that has crystallized out blocking a feed line of a fuel system through which fuel can be supplied to a fuel-oil heat exchanger, a device known from U.S. Pat. No. 9,016,351 B2 for preheating the fuel upstream of the fuel-oil heat exchanger has a number of tubes, which are arranged in at least one plane which intersects the flow direction of the fuel.

The tubes which are arranged in the flow path of the fuel and around which fuel flows influence the flow of the fuel over the entire operating range of the fuel cooling system implemented with the device, which impairs the efficiency of the downstream fuel-oil heat exchanger and is therefore undesirable. The low efficiency necessitates greater dimensioning of the fuel-oil heat exchanger but this increases the required installation space and the production costs of the fuel-oil heat exchanger.

The present disclosure is based on the object of devising a heat exchanger device for aircraft engines comprising a fuel-oil heat exchanger which is constructionally simple and beneficial in terms of installation space and costs and by means of which a supply of fuel is ensured even during unfavourable operating state periods.

This object is achieved by a heat exchanger device having the features of patent claim 1.

The heat exchanger device for an aircraft engine according to the present disclosure comprises a fuel-oil heat exchanger for the indirect transfer of thermal energy between fuel and oil. A feed area of the fuel-oil heat exchanger, through which fuel can be fed to the fuel-oil heat exchanger, is delimited by a front plate of the fuel-oil heat exchanger, through which fuel can flow, and an opposite casing area. In addition, a discharge area is provided for the fuel which emerges from the fuel-oil heat exchanger. The discharge area is arranged on a side of the fuel-oil heat exchanger which faces away from the feed area. Furthermore, fuel can be led through a bypass line extending parallel to the fuel-oil heat exchanger and having a bypass valve for controlling the fuel flow through the bypass line in parallel with the fuel-oil heat exchanger.

At least part of the oil flow which can be led through the fuel-oil heat exchanger can be conducted through the casing area upstream of the fuel-oil heat exchanger, and thermal energy can be transferred indirectly between the oil volume which flows through the casing area and the fuel located in the feed area.

In particular during operating conditions of the heat exchanger device during which at least part of the water entrained by the fuel freezes and blocks the fuel-oil heat exchanger, this offers the possibility of heating the fuel by means of the oil and, above all, of melting the frozen water within short operating times and also of freeing the flow path of the fuel in the feed area of ice again before the bypass line is also clogged by ice.

In a simple way, impairment of the laminar flow of the fuel in non-iced operating states of the feed area is avoided by the transfer of thermal energy originating from the oil in the casing area to the fuel located in the interior of the feed area. This is the case since the indirect heating of the fuel and of the water entrained by the fuel originates from the casing area and not from the flow cross section of the lines traversed by the fuel, as in known solutions. As a result, in the non-iced normal state of the feed area, the fuel can be fed to the fuel-oil heat exchanger with a laminar flow and introduced into the latter with low flow losses, whereby the fuel-oil heat exchanger can be operated with a high efficiency. This makes it possible to design the fuel-oil heat exchanger and, as a result, also the heat exchanger device in a manner which is beneficial to installation space and costs.

If an outlet of the casing area through which oil flows has a fluid connection to the fuel-oil heat exchanger, and the oil flows through the fuel-oil heat exchanger after the casing area, the heat exchanger device has a constructionally simple structure and an oil circuit of an aircraft engine can be implemented with a low number of transfer interfaces, which means that there is only little outlay on sealing.

In a development of the heat exchanger device according to the present disclosure which is likewise beneficial in terms of installation space and costs, in which the flow of the fuel upstream of the fuel-oil heat exchanger is also not influenced, at least part of the oil flow which can be led through the fuel-oil heat exchanger can be conducted through a front plate of the fuel-oil heat exchanger. This offers the possibility of additionally transferring thermal energy indirectly between the fuel located in the feed area and the oil flow led through the front plate, upstream of the fuel-oil heat exchanger. Therefore, icing states of the feed area can be resolved within short operating times, and under-supplies of fuel to an aircraft engine can be avoided, and also the fuel-oil heat exchanger can be operated with high efficiency.

Furthermore, provision can be made for an outlet of the area of the front plate through which oil flows to have a fluid connection to the area of the fuel-oil heat exchanger through which oil flows. The heat exchanger device can then be designed constructionally simply and a fuel circuit of an aircraft engine can be implemented with a low number of transfer interfaces, which means that there is again little outlay on sealing.

If the bypass line branches directly off the inlet of the feed area, then the heat exchanger device needs little installation space. Furthermore, in this embodiment of the heat exchanger device, fuel can be led through the bypass line until the absorption capacity of the feed area is exceeded by ice and ice that has crystallized out also blocks the bypass line. However, this can be avoided with little outlay by appropriate dimensioning of the volume of the feed area and of the quantity of thermal energy which can be transferred from the oil into the interior of the feed area.

The amount of water which has crystallized out or of the ice starting from which a fuel supply of an aircraft engine is impaired both by the iced-up feed area of the fuel-oil heat exchanger and also by the iced-up flow cross section of the bypass line, as compared with the last-named embodiment of the heat exchanger device, is higher if the bypass line branches off from a feed line opening into the feed area upstream of an inlet of the feed area of the fuel-oil heat exchanger.

In a constructionally simple way, the bypass line can open into the discharge area or into a fuel line branching off from the discharge area downstream of the discharge area.

If a casing of the bypass valve is designed to be heatable, then icing of the bypass valve and an under-supply of fuel to an aircraft engine can be prevented in a straightforward manner.

In an embodiment which is beneficial in terms of installation space, in which icing states can be resolved within short operating times by the thermal energy transferred from the oil, the casing area which delimits the feed area is dome-shaped.

If the casing area has on its inner side elements enlarging the heat exchange surface to the interior of the feed area, preferably ribs projecting from the inner side of the casing area into the interior of the feed area, icing states of the feed area can once more be resolved within short operating times and under-supplies of fuel to an aircraft engine can be avoided.

The volume of the feed area can be designed as a function of the thermal energy which can be transferred indirectly to the fuel from the oil which is led through the casing area, and a quantity of ice which crystallizes out of the fuel that can be accommodated in the feed area and up to which icing of the bypass line does not occur.

Furthermore, there is the possibility of designing the volume of the feed area as a function of the thermal energy which can be transferred indirectly to the fuel in the feed area from the oil flow which is led through the front plate.

A further aspect of the present disclosure relates to a gas turbine engine, in particular an aircraft engine, which is designed with a heat exchanger device described in more detail above.

The invention is not limited to the indicated combinations of features in the independent claims or in the claims dependent thereon. Within the scope of the claims, there are furthermore possibilities of combining individual features, in so far as they are apparent from the claims, the following description of embodiments or directly from the drawing. The reference to the drawings by the claims by the use of reference signs is not intended to limit the scope of protection of the claims.

Preferred developments will become apparent from the dependent claims and the following description. Exemplary embodiments of the invention are explained in more detail with reference to the drawing, without being limited thereto.

The single figure of the drawing shows a simplified sectional view of preferred embodiments of the heat exchanger device according to the present disclosure.

In the FIGURE, a sectional view of two embodiments of a heat exchanger device 1 of an aircraft engine, in particular a gas turbine engine comprising a fuel-oil heat exchanger 2 for the indirect transfer of thermal energy between a fuel T and oil OE, is illustrated. The gas turbine engine can be designed in any desired way. The two embodiments differ only in the fact that a branch area 3 of a bypass line 4 for the fuel T is provided at different points of a fuel circuit 5 and in each case upstream of a dome-shaped feed area 6 of the fuel-oil heat exchanger 2, through which fuel T is fed to the fuel-oil heat exchanger 2.

In normal operation, the fuel T flows from the feed area 6 into the fuel-oil heat exchanger 2. In the area of the fuel-oil heat exchanger 2, thermal energy is transferred indirectly to the fuel T from the usually warmer oil OE, which is likewise led through the fuel-oil heat exchanger 2. Therefore, the fuel-oil heat exchanger 2 is also a constituent part of an oil circuit 7 of the aircraft engine.

The feed area 6 of the fuel-oil heat exchanger 2 is delimited by a front plate 8 of the fuel-oil heat exchanger 2, through which fuel T can flow, and an opposite casing area 9. A discharge area 10 of the fuel-oil heat exchanger 2 for the fuel T is located downstream of the area of the fuel-oil heat exchanger 2 in which the fuel T exchanges thermal energy with the oil OE.

During unfavourable operating conditions of the heat exchanger device, there is the possibility that water entrained by the fuel T will crystallize out, depending on the temperature, and ice crystals will accumulate in the feed area 6. Under certain circumstances, this leads to the fuel-oil heat exchanger 2 being blocked by frozen water and it no longer being possible to lead fuel T through the fuel-oil heat exchanger 2. In order to avoid under-supplying the aircraft engine designed with the heat exchanger device 1, the bypass line 4 extending parallel to the fuel-oil heat exchanger 2, which opens into the discharge area 10 or into a fuel line 14 branching off the discharge area 10 downstream of the discharge area 10, depending on the application, comprises a bypass valve 11 for controlling the fuel flow through the bypass line 4. The bypass valve 11 changes to the open state and opens the bypass line 4 as soon the feed pressure of the fuel T exceeds a threshold value.

In the first embodiment of the heat exchanger device 1, the bypass line 4 branches off directly from the inlet 12 of the feed area 6. This ensures that fuel T can be led through the bypass line 4 even if the entire volume of the feed area 6 is blocked with ice crystals.

However, should the volume of the feed area 10 not be sufficient, for example because of a lack of installation space, to completely absorb the quantity of ice crystals that form during unfavourable operating conditions, there is the danger that a feed line 13 upstream of the inlet 12 and also the bypass line 4 will be blocked by ice or snow that forms. The aircraft engine can then no longer be supplied with fuel to the required extent in the long term. In order to avoid such a scenario, in the second embodiment of the heat exchanger device 1, the bypass line 4 already branches off the feed line 13 opening into the feed area 6 in an area 3A, which is at a distance from the inlet 12 and is located upstream of the inlet 12 of the feed area 6 of the fuel-oil heat exchanger 2. This course of the bypass line 4 is illustrated in the figure by dashed lines and offers the possibility of enlarging the volume available to absorb the crystallized-out water upstream of the fuel-oil heat exchanger 2, without enlarging the installation space required for the feed area 6.

In order to be able to resolve icing states of the heat exchanger device 1 in the feed area 6 within the shortest possible operating times, to prevent or at least delay complete blockage of the fuel-oil heat exchanger 2 and also to limit the quantity of ice produced during unfavourable operating conditions, starting from which an under-supply of fuel to the aircraft engine is to be expected, part of the oil flow OE which can be led through the fuel-oil heat exchanger 2, can be guided through a wall 15 of the casing area 9 upstream of the fuel-oil heat exchanger. This offers the possibility of transferring thermal energy indirectly between the oil volume OE flowing through the casing area 9 and the fuel T and also the water that has crystallized out or the ice crystals in the feed area 6 and possibly of melting frozen water.

The area of the casing area 9 through which the oil OE can flow has a fluid connection via an outlet 16 of the casing area 9 to the area of the fuel-oil heat exchanger 2 through which the oil OE flows, in order to be able to supply thermal energy to the fuel T between the feed area 6 and the discharge area 10. In addition, oil OE can also be led through the front plate 8, in order to heat fuel T and possibly to melt frozen water located in the feed area 6. The oil OE led through the front plate 8 is introduced into the fuel-oil heat exchanger 2 from the front plate 8 via an outlet area 18.

In this embodiment of the heat exchanger device 1, thermal energy from the oil OE can be introduced indirectly into the feed area 6 both from the casing area 9 and from the front plate 8. As a result, effective control of the temperature of the fuel T is possible and icing states of the feed area 6 can be resolved within short operating times, and also blockages of the fuel-oil heat exchanger 2 can be avoided.

In order to achieve the best possible transfer of heat between the casing area 9 and the fuel T and frozen water, the casing area 9 can have elements 19 enlarging the heat exchange surface on its inner side 17 delimiting the feed area 6. The elements 19 can be designed, for example, as ribs or the like, which project from the inner side 17 of the casing area 9 into the interior of the feed area 6.

In addition, there is also the possibility that a casing 19 of the bypass valve 11 is designed to be heatable. Then, icing of the bypass valve 11 by water that has crystallized out and which is introduced into the bypass line 4 when the bypass valve 11 is open can be prevented in a straightforward way. For this purpose, for example, there is the possibility of heating the casing 20 with the oil led through the fuel-oil heat exchanger 2, the casing area 9 and/or the front plate 8.

1. A heat exchanger device for an aircraft engine comprising a fuel-oil heat exchanger for the indirect transfer of thermal energy between fuel and oil, having a feed area of the fuel-oil heat exchanger, for the fuel, which is delimited by a front plate of the fuel-oil heat exchanger, through which fuel can flow, and an opposite casing area, and having a discharge area which is arranged on a side of the fuel-oil heat exchanger which faces away from the feed area, wherein fuel can be led through a bypass line extending parallel to the fuel-oil heat exchanger and having a bypass valve for controlling the fuel volume flow through the bypass line, characterized in that at least part of the oil flow which can be led through the fuel-oil heat exchanger can be conducted through the casing area upstream of the fuel-oil heat exchanger, and thermal energy can be transferred indirectly between the oil volume which flows through the casing area and the fuel in the feed area.

2. The heat exchanger device according to claim 1, wherein that an outlet of the casing area through which oil can flow has a fluid connection to the fuel-oil heat exchanger.

3. The heat exchanger device according to claim 1, wherein that at least part of the oil flow which can be led through the fuel-oil heat exchanger can be conducted through a front plate of the fuel-oil heat exchanger, and thermal energy can be transferred indirectly between the fuel located in the feed area and the oil flow led through the front plate, upstream of the fuel-oil heat exchanger.

4. The heat exchanger device according to claim 3, wherein that an outlet area of the area of the front plate through which oil can flow has a fluid connection to the fuel-oil heat exchanger.

5. The heat exchanger device according to claim 1, wherein that the bypass line branches off directly from the inlet of the feed area.

6. The heat exchanger device according to claim 1, wherein that the bypass line branches off from a feed line opening into the feed area upstream of an inlet of the feed area of the fuel-oil heat exchanger.

7. The heat exchanger device according to claim 1, wherein that the bypass line opens into the discharge area or into a fuel line branching off from the discharge area downstream of the discharge area.

8. The heat exchanger device according to claim 1, wherein that a casing of the bypass valve is designed to be heatable.

9. The heat exchanger device according to claim 1, wherein that the casing area which delimits the feed area is dome-shaped.

10. The heat exchanger device according to claim 1, wherein that the casing area has on its inner side elements enlarging the heat exchange surface, preferably ribs projecting from the inner side of the casing area into the interior of the feed area.

11. The heat exchanger device according to claim 1, wherein that the volume of the feed area is designed as a function of the thermal energy which can be transferred indirectly to the fuel in the feed area from the oil which is led through the casing area, and of a quantity of ice that can be accommodated in the feed area, which crystallizes out from the fuel and up to which icing of the bypass line does not occur.

12. The heat exchanger device according to claim 11, wherein that the volume of the feed area is designed as a function of the thermal energy which can be transferred indirectly to the fuel in the feed area from the oil flow which is led through the front plate.

13. A gas turbine engine, in particular aircraft engine, which is designed with a heat exchanger device according to claim 1.
